(19) United States
(12) Patent Application Publication
(10) Pub. No.: US 2025/0323473 A1
(43) Pub. Date: Oct. 16, 2025

(54) Enclosure for Electrical Interface

(71) Applicant: DBT Holdings LLC, Pittsburgh, PA (US)

(72) Inventor: Levi Weiss, Pittsburgh, PA (US)

(21) Appl. No.: 18/632,133

(22) Filed: Apr. 10, 2024

(51) Int. Cl. B60L 53/16; A47B 81/00; A47B 96/06

(52) U.S. Cl. CPC H02B 1/40; B60L 53/16; H02B 1/42; H02B 1/44; A47B 81/00; A47B 96/06

(57) ABSTRACT

An enclosure for covering electrical interfaces such as a vehicle charging port. The enclosure is configured in a manner that protects the interface without compromising ease of access. The enclosure may be used with different types, shapes, and sizes of interfaces—even if they are pre-installed. The enclosure provides features for easy stowage of cables and appendages.

### BACKGROUND

A current need exists for easy-to-use and durable enclosures and more particularly for enclosures to protect, seal off, or otherwise cover charging stations. With the increase in electrical modes of transportation such as scooters, bicycles, planes, automobiles, or even drones, more electrical charging stations are appearing in areas not typically outfitted with electrical outlets. Moreover, these charging ports or stations come in various designs, shapes, and sizes-some unsightly and some exposed. Accordingly, there exists a need to provide an enclosure that can be used to cover, seal, or protect electrical charging stations, ports, or any similarly electrically-charged interfaces.

### BRIEF SUMMARY

The disclosed embodiments provide a solution for housing, protection, security, and even the aesthetic presentation of electrically-charged interfaces (“interfaces”) such as an outlet, a charging port, sprinkler controls, security controls, and the like.

One embodiment of the enclosure is for covering an electrical vehicle charging port and comprises a body and door. The back side of the body includes an opening and a ledge. The ledge has mounting portions adapted for mounting the enclosure onto a mounting surface. The enclosure door also includes a rim. The rim may be adjacent a channel and a shoulder, which may contain additional sealing material. The rim may interact with the enclosure body to close the enclosure, define an interior, and seal it. The rim allows the water to drain from the bottom and not drip into the box.

A hanger may be coupled to the door and sized to fit inside said interior; wherein the hanger is configured for holding an elongated member thereon. The elongated member may be the cable for charging the electric vehicle. But it may have other uses. Moreover, the hanger may take various forms and shapes. In one embodiment, the hanger includes a body portion and a bridge portion.

The enclosure may include mounting holes positioned on the back side and configured for fastening the enclosure body to the mounting surface. The back side may interact with a mounting bracket for mounting the enclosure.

The enclosure body may include an additional opening on the bottom, or at another location, configured to allow passage of an elongated member or the charging cable. The enclosure may include a knob, handle, lock, latch, or keyless entry device.

The present invention also contemplates methods of making and using the enclosure. In one embodiment, the method of providing an enclosure comprises providing an enclosure body and an enclosure door adapted to be coupled by a hinge. The enclosure body may include an opening and a ledge, and the enclosure door may have a rim. The rim may engage the enclosure body to close the enclosure. Moreover, the enclosure includes a hanger which protrudes into the interior and is adapted for storage of appendages including charging cables for electrical vehicles.

The present method contemplates mounting the enclosure body to a mounting surface by securing the ledge to the mounting surface. The enclosure includes an interior which is adapted for enclosing an electrical or mechanical interface including an electrical vehicle charger. The present invention contemplates the combination of the enclosure and the charger or electrical interface, as well as the method of mounting the enclosure over the interface.

### BRIEF DESCRIPTION OF THE DRAWINGS

FIG. 1 is perspective view of an embodiment of the enclosure showing the front.

FIG. 2 is a perspective view from the bottom, hinge side, showing the back of one embodiment of the enclosure.

FIG. 3 is a plan view of the front.

FIG. 4 is a plan view of the back.

FIG. 5 is a plan view of one side (left) showing the hinges.

FIG. 6 is a plan view of another side (right).

FIG. 7 is a plan view of the top of one embodiment of the enclosure.

FIG. 8 is a plan view of the bottom of one embodiment of the enclosure.

FIG. 9 is a perspective view of an embodiment from the front with the door open and the door handle in the open position.

FIG. 10 is a perspective view of an embodiment from the back with the door open.

FIG. 11A is a perspective view of the back with an embodiments of a bracket.

FIG. 11B is a sectional side view showing an embodiment of an enclosure mounted on an embodiment of a bracket.

FIG. 12 is a perspective view showing the inside of a door according to one embodiment.

FIG. 13 is a detailed view of a lock according to one embodiment.

FIGS. 14A-C are side elevation views of alternative configurations for a hanger.

### DETAILED DESCRIPTION

The enclosure is particularly designed so that it may be used with a wide variety of configurations, enabling the users to enjoy the benefits of the enclosure irrespective of the interface it cover. An added benefit is that many different interfaces may be covered with enclosures that look the same, thereby creating a clean and organized appearance of an otherwise unsightly electrical interfaces, cables, wires, and related appendages.

Moreover, the enclosure helps protect the interface that it covers. The enclosure can seal the interface from ambient contaminants such as water and debris. It can protect the interface from birds, squirrels, mice, or other animals or insects. It may provide security against theft or tampering if locked. It may also help prolong the life of the cable or cords attached to the interface by providing a protected storage which does not bend or kink the cable while stored. Even if the enclosure is not rated as fireproof, when constructed of metal or fire-resistant material, it is capable of providing some protection against fire, heat, and smoke. If the enclosure is sealed against the surface which is mounted on, for example with sealing silicone or caulk, it may provide protection against rain or water from an activated sprinkler.

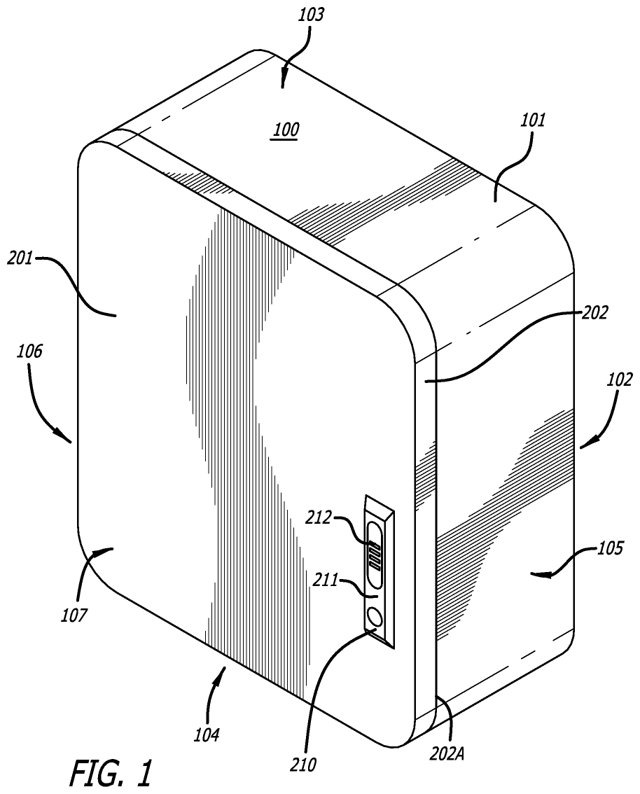

These and other benefits are achieved by the various embodiments described herein with respect to FIGS. 1-14C. The embodiments described here, may be created in a variety of shapes and sizes. The teachings here are applicable to any type of enclosure that is designed to cover utility or electrical interfaces.

In the following detailed description, numerous specific details are set forth by way of examples in order to provide a thorough understanding of the relevant teachings of this application. It should be noted, however, that the present teachings may be practiced without such details. In other instances, known methods, procedures and components have been described at a relatively high level, without detail, in order to avoid unnecessarily obscuring aspects of the teachings.

The enclosure may be created from different materials consistent with its use. Location of installation, size, weight, fire resistance, water resistance, induction and interference, and hermetic capabilities include a few of the considerations relevant to selection of a particular configuration or a particular material for construction. For general use to cover electrical charging ports or sprinkler system controls, enclosures may be constructed from steel. Alternatively, other materials including aluminum, plastic, glass, or fire resistant materials may also be used.

FIG. 1 depicts the enclosure 100 with a body portion 101 and a door portion 201. The enclosure 100 has back side 102, top side 103, bottom side 104, right side 105, left side 106, and front side 107.

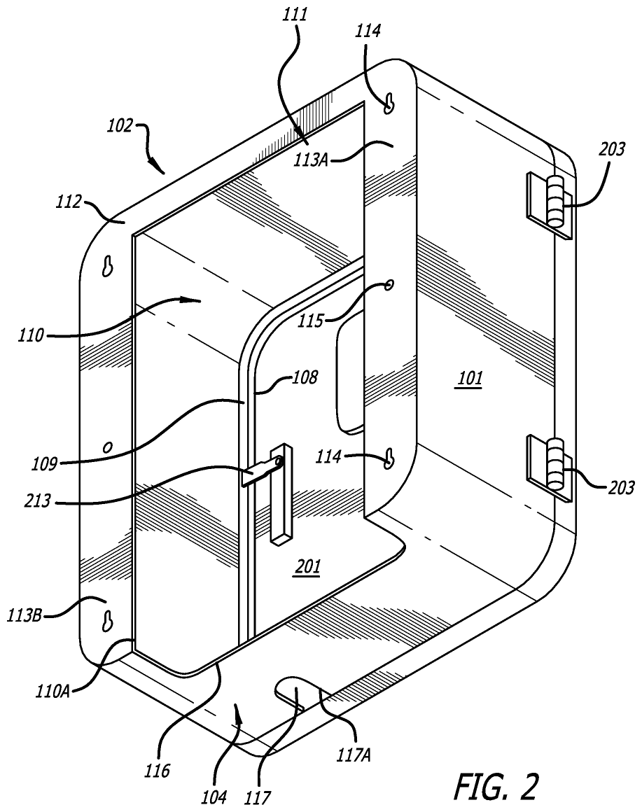

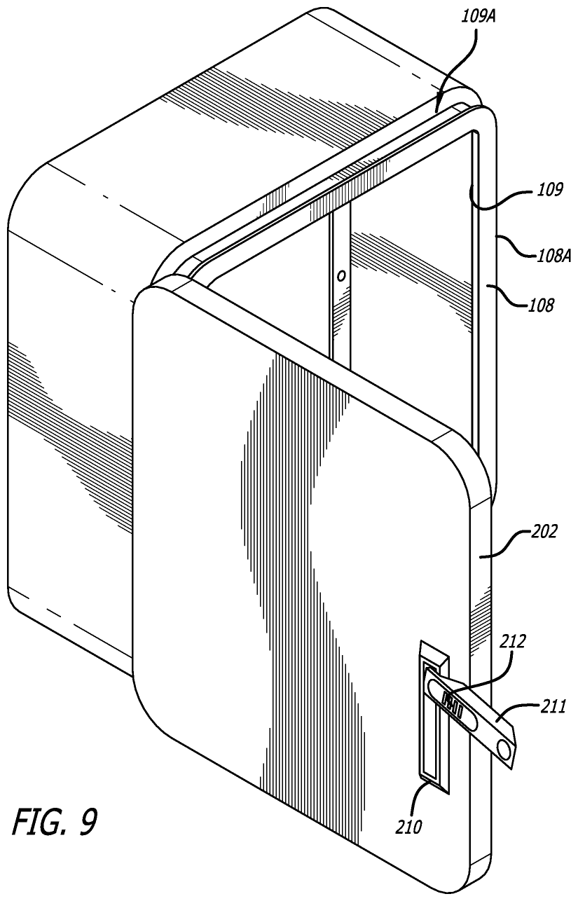

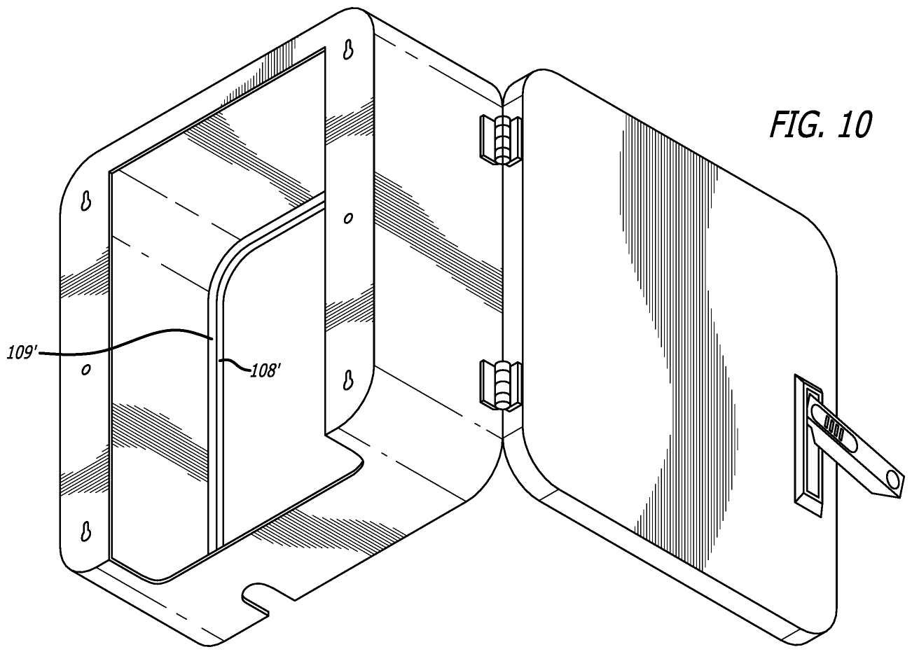

The body 101 has a front rim 108 (FIGS. 2 and 9) on the side facing the door. The front rim may be positioned on a shoulder 109 which provides a ledge for engagement with a latch or lock (FIG. 2). The corresponding rim and shoulder are depicted as 108′ and 109′ in FIG. 10.

The door 201 as shown in the embodiment of FIG. 1 (and FIG. 9) has a lip 202 which is perpendicular to the front surface of the door and acts to engage the front rim 108 upon closure. On the side, facing exterior of the enclosure 101, the rim 108 forms a channel 109A created by the body of the enclosure and the shoulder 109. This channel assists in sealing the door against the enclosure with a friction fit without the need for an additional seal. Moreover, the shape of the channel with the rim provide a seal through which air may flow but water will not penetrate into the interior of the enclosure. Water which may seep into the seam 202A (FIG. 1), will be trapped in the channel, blocked by the rim, and not ingress further into the enclosure. It may then drain from the bottom. If the flat terminus of the rim 108A is configured to seal against the door 201 (FIG. 9) or if additional sealing material is used in combination with the rim 108, the seal can be enhanced or made hermetic. The additional sealing material may be a gasket or deformable sealing material. Some deformable sealing materials include foam, silicone, and rubber. The sealing material may be placed inside the channel 109A, on the rim 108, on the surface of the flat terminus of rim 108, or against the lip 202.

The door 201 may also include one or more hinges 203. Hinges 203 may be traditional door hinges secured with fasteners, may be hinges built into the body or door, may be an integral or living hinge made by a reduced thickness of the enclosure material or from a different but flexible material. The function of the hinge is to enable the door 201 to pivot about the hinge axis from right to left (in this embodiment) so that the door opens and shuts.

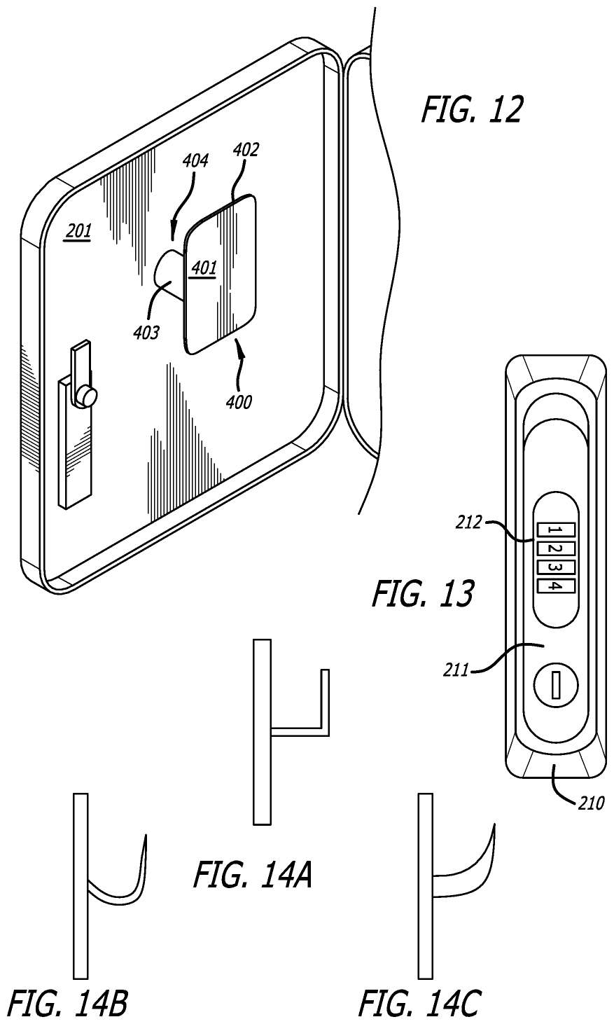

Door 201 may also include a latch, knob, handle, or lock 210. In the embodiment of FIGS. 1 and 9, the lock 210 includes a handle 211 and a keypad lock 212. The handle 211 may be lifted and turned to the right, acting as a lever that rotates the latch 213 down and out of engagement with the shoulder 109 thereby disengaging the door and allowing it to open (FIGS. 2 and 12). The locking mechanism which is activated and deactivated by the keypad controls in this embodiment controls the rotation of the handle and the ability to prevent the door 201 from unlatching upon rotation of the handle 211 thereby keeping the door lock. One embodiment of such a latch or lock is depicted in FIG. 13.

Many types of locks, knobs, and latches are known in the industry including fully electronic locks; remotely controlled locks; programmable keyless entry locks; simple key locks; latches with tabs for placement of combination locks; and various more or less sophisticated variations. Accordingly, the enclosure is capable of being outfitted with many different types of locks, knobs, and latches.

The particular style of lock shown in combination with the enclosure in FIG. 1 has specific benefits. For example, the handle-style portion of the knob allows a substantial force to be used to open the door if the lip 202 and rim 108 are jammed, for example from expansion and contraction or deformation of the body. Moreover, the keypad-style lock provides a secure enclosure without the need for separate keys. The key-pad style lock may be programmable and capable of being operated remotely, for example by using a mobile phone app. Moreover, the entire construct of the lock including the latch 213 is a simple construct which is secure, durable, hard to tamper with, but easy to manufacture and cost-effective.

FIG. 2 shows a perspective view of the back side of the enclosure. The door 201 and enclosure 101 define an interior volume 110. All enclosed equipment, for example a charging station, may be enclosed within volume 110. The hanger for cables and appendages may also enclosed within this volume.

The back 102 of the enclosure is not closed. The back side 102 includes an opening 111 which permits the enclosure to be mounted on or retrofitted to existing interfaces without the need to alter, unmount, or disconnect the interface. This is a great benefit because it allows the enclosure to be used with practically any interface and without the need to alter the interface, thereby saving time and money. It further allows use with interfaces that cannot be dismounted or disconnected.

Back 102 includes a ledge extending a portion of its perimeter, for example on the top and sides as shown in FIG. 2. The ledge may extend along the entire perimeter of the back and may be uniform in size. But it may not be, for example as shown in FIG. 2. In the embodiment of FIG. 2, the top ledge 112 is narrower in breadth than shelves 113A-B on the right and left sides. The ledge and the shelves may be made narrow or broad. Any or all of ledge 112 and shelves 113A-B, may provide the mounting mechanism for the enclosure.

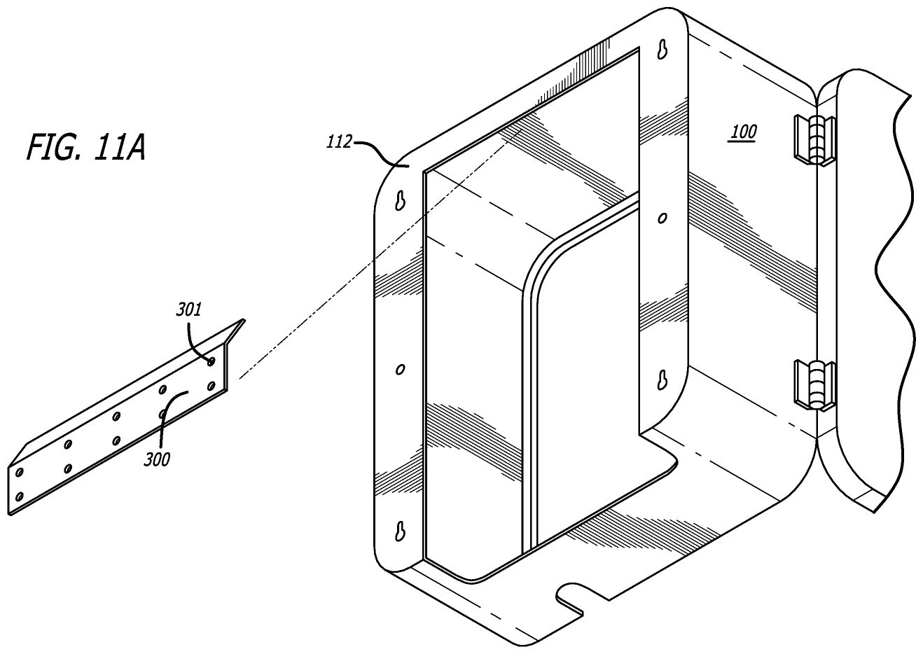

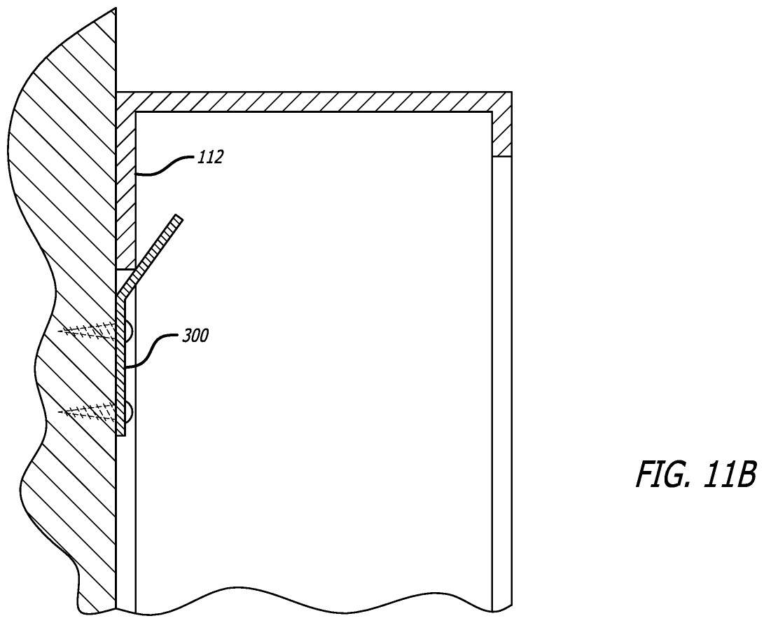

In the embodiment of FIG. 2, the mounting mechanism includes mounting holes 114 so that the enclosure may be fastened against a mounting surface. Different shapes and types of such openings may be provided. For example, the center openings 115 in this embodiment as made as simple round holes instead of key holes. These round holes may be used for direct mounting with a fastener from the interior of the enclosure or can be used to secure the enclosure to a bracket as more fully shown in FIGS. 11A-B.

With reference to FIGS. 11A-B, a bracket 300 may be secured to the mounting surface, for example a residential garage wall, with the openings 301, for example, 16 inches on center to match placement of studs in residential structures. The enclosure 100 is then hung on the bracket which engages one or more of the mounting holes on the enclosure. The enclosure 100 may also be fastened to the mounting surface directly. Holes 114 or 115 may be used to mount the enclosure to the mounting surface. Moreover, one or more brackets may be used with an enclosure.

In the embodiment of 11B, the bracket includes an angled portion (shown), hook (not shown), or step (not shown) which allows the enclosure to hang on it for mounting. That is, the hanging bracket is secured to the mounting surface, for example by one or more fasteners. The top portion of the hanging bracket is spaced from the mounting surface and provides a step or engagement portion which interacts with the ledge 112, thereby allowing the enclosure to hang on the bracket. If desirable, additional fasteners can be used to secure the enclosure to the mounting surface or to the bracket so that it may not be lifted off the bracket.

With reference to FIG. 2, the bottom 104 may have one or more cutout portions. In the embodiment of FIG. 2, the cutout 116 is contiguous with the perimeter 110A of the back of the enclosure. Alternatively, cutout 116 may be eliminated. Alternatively, the shoulders 113A-B may extend around the entire perimeter of the back including along the bottom 104. The interior perimeter of cutout 116 may be formed in different shapes. Additionally, the interior perimeter of cutout 116 may be covered by a gasket or a cover which prevents or reduces chaffing and may seal the interior 110.

The bottom 104 may include a second cutout 117. Cutout 117 may be sized to fit one or more cables which connect with the interface covered by the enclosure. These cables may be incoming power cords, outgoing power cords, or other cords, pipes, or appendages coupled to the interface. Alternatively, cutout 117 may be eliminated. The interior perimeter 117A of cutout 117 may be oval or circular. Moreover, the perimeter 117A may be covered by a gasket which prevents or reduces chaffing or by a bushing or cover which may seal the opening. While cutout 117 is shown on the bottom in this embodiment, it may positioned at other locations such as the top, front, or side of the enclosure.

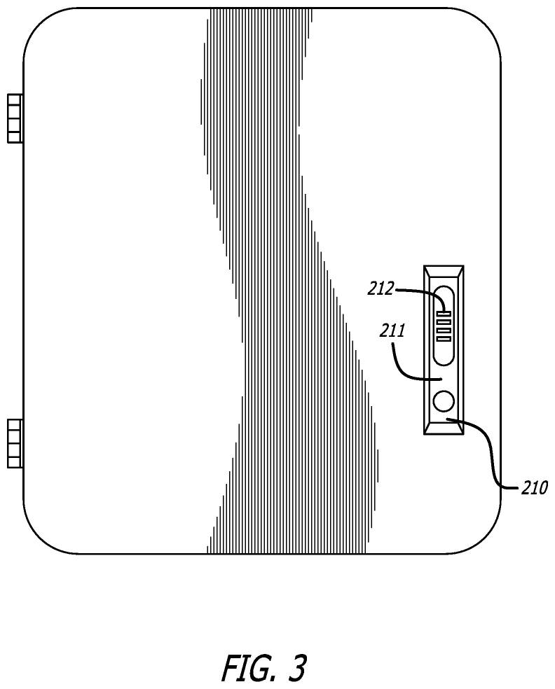

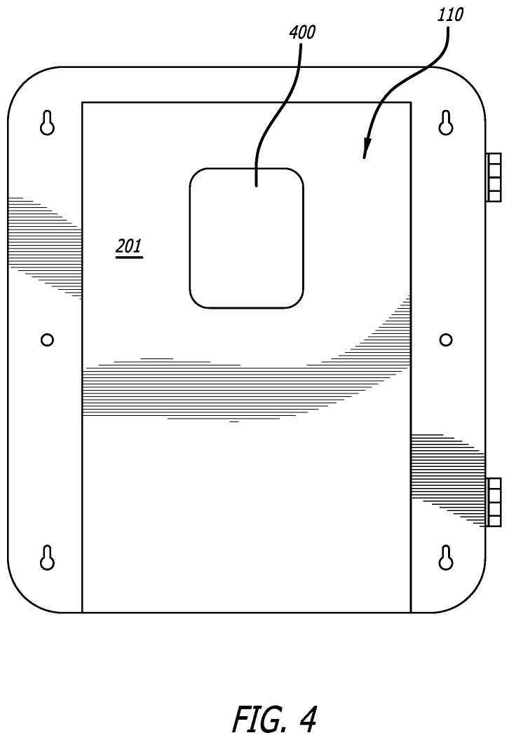

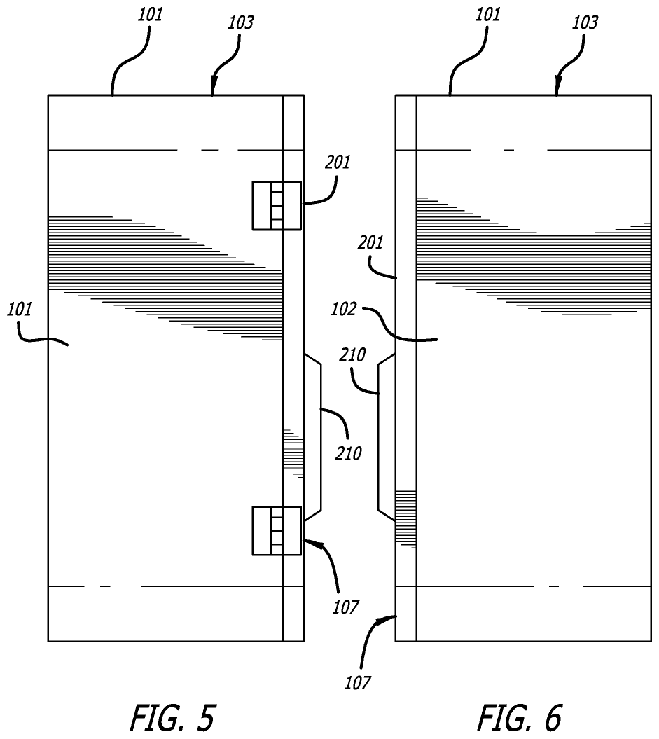

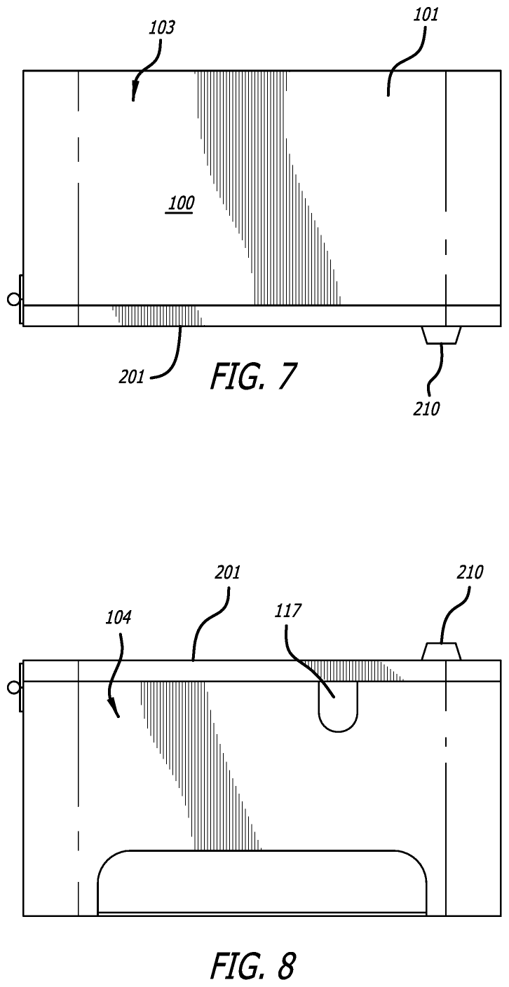

FIGS. 3-8 show each of the sides of an embodiment of the enclosure. FIG. 3 shows an embodiment of the enclosure from the front with the door closed and mounted on a mounting surface. FIG. 4 shows the rear of an unmounted enclosure. FIG. 5 is a plan side view of an embodiment showing the enclosure as would be seen mounted on a mounting surface with the door closed and latched. FIG. 6 is the plan view of the other side of that embodiment. FIG. 7 is the top plan view. FIG. 8 is the bottom with the door closed. But none of the appendages or the interface components are shown in these figures. The sleek and clean design contribute to the enclosures aesthetic benefits in addition to the functional ones.

With reference to FIG. 4, interior 110 of the enclosure is shown revealing the back side of door 201. Formed on the back of door 201 is hanger 400. As more fully seen in FIG. 12, hanger 400 includes a body 401 with an edge 402 which extends along the perimeter of the hanger body 401. The edge 402 is spaced from the door 201 by bridge 403 which creates a space 404 between the door 201 and the edge 402. Space 404 may be used for storage of cords, power cables, and the like which may be hung on bridge 403. In this way, the enclosure not only protects the interface but also the appendages to it, in a manner that is secure and does not cause kinks or damage.

The placement of the hanger on the door is a feature that enhances the functionality of the enclosure. The cable or appendage, for example for the charging station, is stored on the hanger and is neatly tucked away from the interface but within the enclosure. Moreover, it is easily wrapped and stowed—or unwrapped for use—and provides ready and easy access to the user upon opening of the door. In contrast to enclosures without the hanger, the present enclosures drastically improve durability and ease of use by allowing stowing of a cord or appendage securely inside the enclosure.

In alternative embodiments, the hanger may be adjustably placed on the door. For example, the door may include multiple mounting locations for the hanger. The hanger may be placed in any of the mounting locations for the hanger in a customize way. FIGS. 14A-C show a few alternative configurations for the hanger.

The enclosure, door, bracket, hanger, knob, handle, lock, or latch may be formed of metal, plastic, wood, other materials, or combinations thereof. The door or enclosure may include glass windows or include transparent plastic. The parts may be shaped, formed, rolled, molded, casted, welded, or glued together. They may be formed integrally in one piece and may be formed as a unitary structure. Alternatively, the enclosure may be formed as a unitary structure, the door and hanger as another unitary structure, with the two connected by one or more hinges. The door and the hanger may be formed integrally, unitary, or coupled with fasteners. The hanger may also be welded, glued, or otherwise permanently coupled to the door. Although, in this latter embodiment the hanger will not be moveable into different positions on the door as explained earlier. Moreover, by selecting the correct size for the enclosure for the particular choice of interface, and by selecting the correct relative size of hanger, a high level of functionality is imparted, such that the benefits and ease of use of the enclosure far exceed those of the prior art enclosures.

Various modifications and methods of implementation within the scope of this disclosure will be apparent to the person of ordinary skill in the art upon consideration of the teachings herein. Those variations do not depart from the scope and spirit of these teachings. Such modifications or variations are contemplated by the applicant and the teachings herein are intended as explanations to illuminate the present invention and not as limiting examples. The breadth and scope of the claims are not to be limited by the particulars set forth in the specific embodiments.

We claim:

1. An enclosure for covering an electrical vehicle charging port comprising:
an enclosure body having a front side, a back side, a top, a bottom, a right side, and a left side;
an enclosure door;
the back side comprising an opening;
the opening comprising a ledge; wherein the ledge has mounting portions adapted for mounting the enclosure onto a mounting surface;
the enclosure door having a lip; said lip engaging the enclosure body to close the enclosure and define an interior; and
a hanger coupled to the door and sized to fit inside said interior; wherein the hanger is configured for holding an elongated member thereon.

2. The enclosure of claim 1 wherein the hanger includes a body portion and a bridge portion.

3. The enclosure of claim 1 further comprising mounting holes positioned on the back side and configured for fastening the enclosure body to the mounting surface.

4. The enclosure of claim 1 wherein the enclosure body further comprises an additional opening configured to allow passage of an elongated member.

5. The enclosure of claim 1 further comprising a mounting bracket that engages the ledge.

6. The enclosure of claim 1 further comprising a knob, handle, lock, latch, or keyless entry device.

7. The enclosure according to claim 1 wherein the enclosure body further includes a rim which includes a shoulder in the interior.

8. An enclosure comprising:
an enclosure body and an enclosure door;
the enclosure body having a front side, back side, top, bottom, right side, and left side;
the back side including an opening and a ledge; wherein the ledge has mounting portions for mounting the enclosure onto a mounting surface;
the enclosure door having a lip; said lip engaging the enclosure body to close the enclosure and define an interior;
the enclosure door coupled to a hanger which protrudes into the interior and is adapted for storage of appendages; and
the enclosure door further including a knob, handle, lock, or latch.

9. The enclosure according to claim 8 wherein the knob, handle, lock, or latch comprise a keyless entry device.

10. The enclosure according to claim 8 wherein the enclosure body further includes a rim which includes a shoulder in the interior.

11. The enclosure according to claim 8 wherein the enclosure body further includes a rim which includes a channel.

12. The enclosure according to claim 11 wherein the channel faces the exterior.

13. A method of providing an enclosure comprising the steps of
providing an enclosure body and an enclosure door adapted to be coupled by a hinge;
providing the enclosure body with a front side, back side, top, bottom, right side, and left side; the back side including an opening and a ledge; the enclosure door having a lip; said lip engaging the enclosure body to close the enclosure; the enclosure door coupled to a hanger which protrudes into the interior and is adapted for storage of appendages; wherein the hanger is contained in an interior space of said enclosure body,
mounting said enclosure body to a mounting surface by securing said ledge to the mounting surface; wherein the mounting surface, the door, and the enclosure body define an interior; wherein the interior is adapted for enclosing an electrical or mechanical interface.

14. The method according to claim 13 wherein said securing said ledge comprises coupling said ledge to a mounting bracket which is securing to said mounting surface.

15. The method according to claim 13 further in combination with a charging station for an electrical vehicle.

16. The method according to claim 15 where said charging station is mounted on the mounting surface.
